(19) United States
(12) Patent Application Publication
(10) Pub. No.: US 2018/0331383 A1
(43) Pub. Date: Nov. 15, 2018

(54) GASKET ASSEMBLIES FOR REDOX FLOW BATTERIES

(71) Applicants: Jinfeng Wu, Mukilteo, WA (US); Liyu Li, Bellevue, WA (US); Lijun Bai, Mukilteo, WA (US); Qingtao Luo, Mukilteo, WA (US); Guanguang Xia, Everett, WA (US); Yueqi Liu, Mukilteo, WA (US)

(72) Inventors: Jinfeng Wu, Mukilteo, WA (US); Liyu Li, Bellevue, WA (US); Lijun Bai, Mukilteo, WA (US); Qingtao Luo, Mukilteo, WA (US); Guanguang Xia, Everett, WA (US); Yueqi Liu, Mukilteo, WA (US)

(21) Appl. No.: 15/975,684

(22) Filed: May 9, 2018

Related U.S. Application Data
(60) Provisional application No. 62/503,852, filed on May 9, 2017.

(51) Int. Cl. H01M 8/18; H01M 8/242; H01M 2/40

(52) U.S. Cl. CPC H01M 8/188; H01M 2/40; H01M 8/242

(57) ABSTRACT

In one embodiment, a cell in a redox flow battery includes a first flow frame for flow of a catholyte, a second flow frame for flow of an anolyte, and a separator between the first flow frame and the second flow frame, wherein the separator has a first side and a second side and an outer perimeter, and a gasket-and-separator assembly including a gasket assembly laminated to the separator, wherein the gasket assembly seals the outer perimeter of the separator on the first side and the second side.

### CROSS-REFERENCE TO RELATED APPLICATION

This application claims the benefit of U.S. Provisional Application No. 62/503,852, filed May 9, 2017, the disclosure of which is hereby expressly incorporated by reference herein in its entirety.

### BACKGROUND

Concerns over the environmental consequences of burning fossil fuels have led to an increasing use of renewable energy generated from sources such as solar and wind. The intermittent and varied nature of such renewable energy sources, however, has made it difficult to fully integrate these energy sources into existing electrical power grids and distribution networks. A solution to this problem has been to employ large-scale electrical energy storage (EES) systems. These systems are widely considered to be an effective approach to improve the reliability, power quality, and economy of renewable energy derived from solar or wind sources.

In addition to facilitating the integration of renewable wind and solar energy, large scale EES systems also may have the potential to provide additional value to electrical grid management, for example: resource and market services at the bulk power system level, such as frequency regulation, spinning reserves, fast ramping capacity, black start capacity, and alternatives for fossil fuel peaking systems; transmission and delivery support by increasing capability of existing assets and deferring grid upgrade investments; micro-grid support; and peak shaving and power shifting.

Among the most promising large-scale EES technologies are redox flow batteries (RFBs). RFBs are special electrochemical systems that can repeatedly store and convert megawatt-hours (MWhs) of electrical energy to chemical energy and chemical energy back to electrical energy when needed. RFBs are well-suited for energy storage because of their ability to tolerate fluctuating power supplies, bear repetitive charge/discharge cycles at maximum rates, initiate charge/discharge cycling at any state of charge, design energy storage capacity and power for a given system independently, deliver long cycle life, and operate safely without fire hazards inherent in some other designs.

In simplified terms, an RFB electrochemical cell is a device capable of either deriving electrical energy from chemical reactions, or facilitating chemical reactions through the introduction of electrical energy. In general, an electrochemical cell includes two half-cells, each having an electrolyte. The two half-cells may use the same electrolyte, or they may use different electrolytes. With the introduction of electrical energy, species from one half-cell lose electrons (oxidation) to their electrode while species from the other half-cell gain electrons (reduction) from their electrode.

Multiple RFB electrochemical cells electrically connected together in series within a common housing are generally referred to as an electrochemical “stack”. Multiple stacks electrically connected together are generally referred to as a “string”. Multiple stings electrically connected together are generally referred to as a “site”.

A common RFB electrochemical cell configuration includes two opposing electrodes separated by an ion exchange membrane or other separator, and two circulating electrolyte solutions, referred to as the “anolyte” and “catholyte”. The energy conversion between electrical energy and chemical potential occurs instantly at the electrodes when the liquid electrolyte begins to flow through the cells.

To meet industrial demands for efficient, flexible, rugged, compact, and reliable large-scale ESS systems with rapid, scalable, and low-cost deployment, there is a need for improved RFB systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a cell in a redox flow battery is provided. The cell includes a first flow frame for flow of a catholyte, a second flow frame for flow of an anolyte, and a separator between the first flow frame and the second flow frame, wherein the separator has a first side and a second side and an outer perimeter, and a gasket-and-separator assembly including a gasket assembly laminated to the separator, wherein the gasket assembly seals the outer perimeter of the separator on the first side and the second side.

In accordance with another embodiment of the present disclosure, a method of making a cell for a redox flow battery is provided. The method includes laminating a gasket-and-separator assembly including a gasket assembly laminated to the separator, wherein the separator has a first side and a second side and an outer perimeter and wherein the gasket assembly seals the outer perimeter of the separator on the first side and the second side, and disposing the gasket-and-separator assembly between a first flow frame for flow of a catholyte, a second flow frame for flow of an anolyte.

In accordance with another embodiment of the present disclosure, a redox flow battery stack of cells is provided. The stack includes a plurality of adjacent cells, each cell including a first flow frame for flow of a catholyte, a second flow frame for flow of an anolyte, and a separator between the first flow frame and the second flow frame, wherein the separator has a first side and a second side and an outer perimeter, and a gasket-and-separator assembly including a gasket assembly laminated to the separator, wherein the gasket assembly seals the outer perimeter of the separator on the first side and the second side.

In any of the embodiments described herein, the separator may be a membrane or a bipolar plate.

In any of the embodiments described herein, the outer perimeter of the separator may be aligned with the outer perimeter of the gasket assembly.

In any of the embodiments described herein, the outer perimeter of the separator may be embedded within the gasket assembly.

In any of the embodiments described herein, the gasket assembly may include a first gasket and a second gasket.

In any of the embodiments described herein, the first gasket may contact the first side of the separator and the second gasket may contact the second side of the separator.

In any of the embodiments described herein, the gasket-and-separator assembly may be formed by pressing the separator between the first gasket and the second gasket.

In any of the embodiments described herein, the first and second gaskets may have flat inner and outer surfaces.

In any of the embodiments described herein, at least one of the first and second gaskets may have a stepped inner surface.

In any of the embodiments described herein, the step of the stepped inner surface may have substantially the same thickness as the separator.

In any of the embodiments described herein, the step of the stepped inner surface may have substantially ½ the thickness of the membrane.

In any of the embodiments described herein, the gasket assembly may further include a filler portion between the first and second gaskets.

In any of the embodiments described herein, the filler portion may be a plastic film or a third gasket.

In any of the embodiments described herein, the plastic film may be selected from the group consisting of polyvinyl chloride (PVC), chlorinated polyvinyl chloride (CPVC), polypropylene (PP), polyvinylidene fluoride (PVDF), polyamide (PA), acrylonitrile butadiene styrene (ABS), polyethylene terephthalate (PET), polytetrafluoroethylene (PTFE), and combinations thereof.

In any of the embodiments described herein, the pressing pressure may be in the range of 0.01 to 100 MPa.

In any of the embodiments described herein, the pressing time may be in the range of 0.01 to 1000 minutes.

In any of the embodiments described herein, the material for the gasket assembly may be a rubber material selected from the group consisting of acrylonitrile butadiene styrene (ABS) rubber, fluorine rubber, chloroprene rubber, nitrile butadiene rubber, polyisoprene rubber, natural rubber, butyl rubber, ethylene propylene diene monomer (EPDM) rubber, polybutadiene rubber, acrylic rubber, silicone rubber, and combinations thereof.

In any of the embodiments described herein, the surface of the gasket assembly may be prepared prior to pressing.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an isometric view of a redox flow battery (RFB) module in accordance with one embodiment of the present disclosure;

FIG. 2 is an isometric view of the RFB module of FIG. 1 with the outer container removed;

FIGS. 3A and 3B are schematic views of various components of the RFB module of FIGS. 1 and 2;

FIG. 4 is schematic view of a 1 MW site in accordance with one embodiment of the present disclosure;

FIGS. 5A and 5B are side and exploded views of a cell stack for an RFB module in accordance with embodiments of the present disclosure;

FIG. 5C is an exploded view of a cell stack for an RFB module in accordance with embodiments of the present disclosure including preassembled gasket-and-separator assemblies;

FIGS. 6A and 6B are side and cross-sectional views of a gasket-and-separator assembly in accordance with one embodiment of the present disclosure;

FIGS. 7A and 7B are side and cross-sectional views of a gasket-and-separator assembly in accordance with another embodiment of the present disclosure;

FIGS. 8A and 8B are side and cross-sectional views of a gasket-and-separator assembly in accordance with another embodiment of the present disclosure;

FIGS. 9A and 9B are side and cross-sectional views of a gasket-and-separator assembly in accordance with another embodiment of the present disclosure;

FIGS. 10A and 10B are side and cross-sectional views of a gasket-and-separator assembly in accordance with one embodiment of the present disclosure; and

FIGS. 11A and 11B are side and cross-sectional views of a gasket-and-separator assembly in accordance with another embodiment of the present disclosure.

### DETAILED DESCRIPTION

Embodiments of the present disclosure are directed redox flow batteries having cell stacks including cells having gasket-and-separator assemblies. Other embodiments of the present disclosure are directed to cells having gasket-and-separator assemblies. Embodiments of the present disclosure are directed to the assembly of cells and cell stacks including cells having gasket-and-separator assemblies.

### Redox Flow Battery

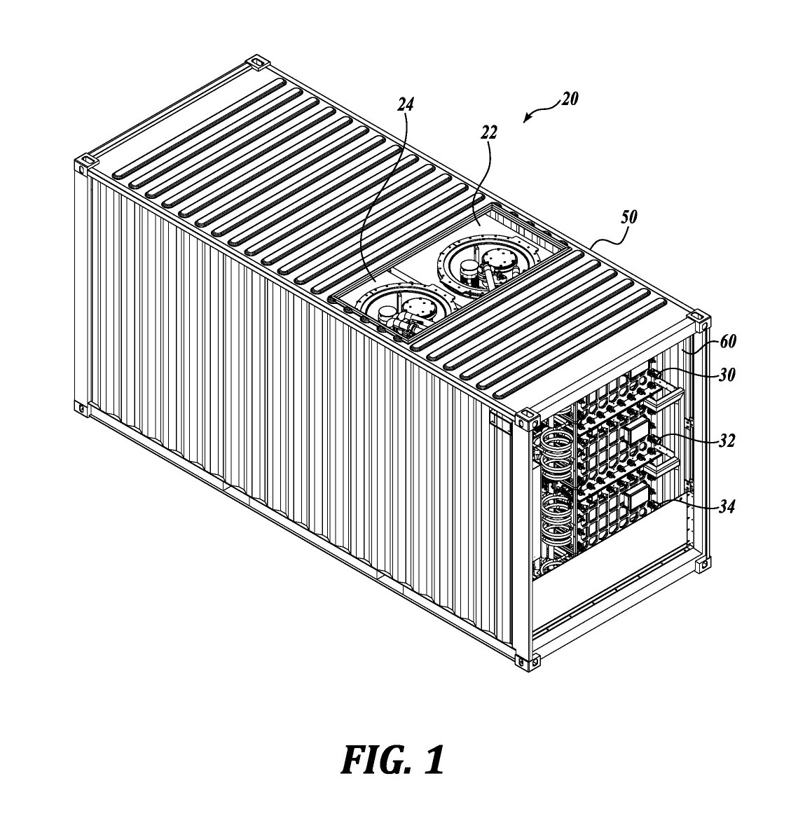

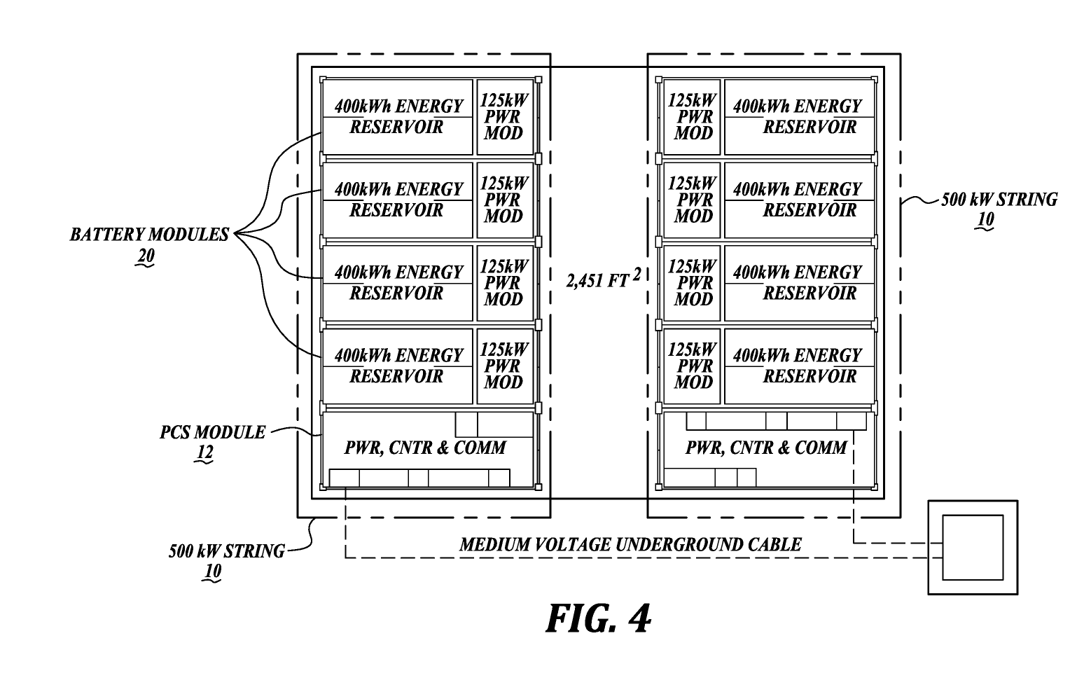

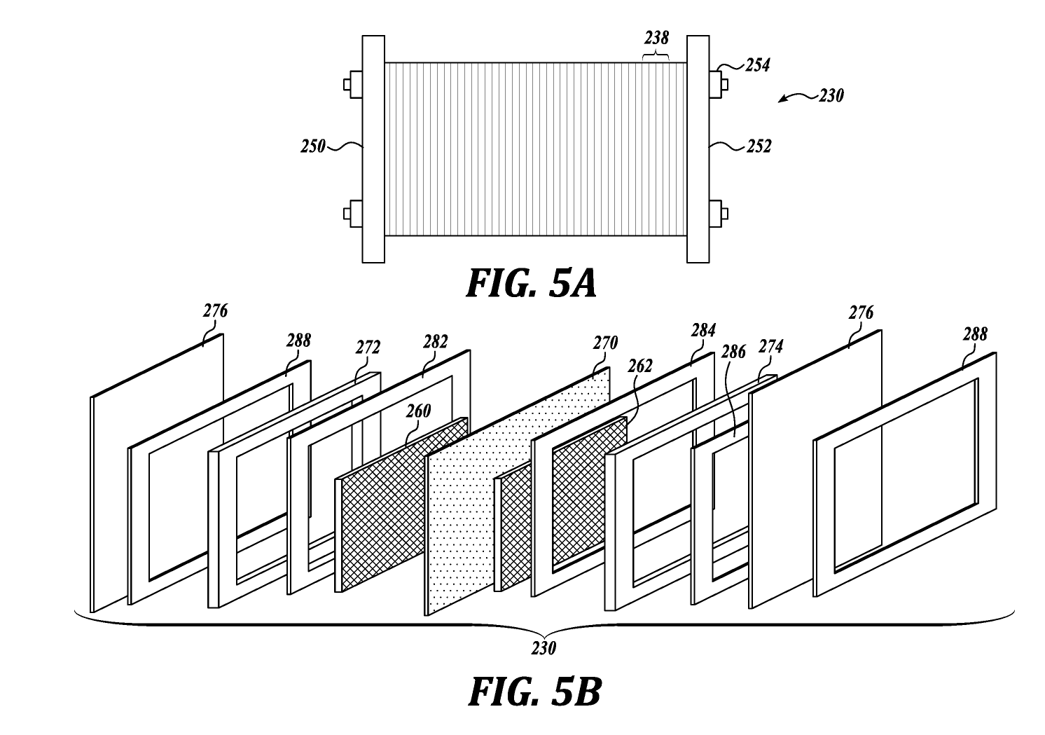

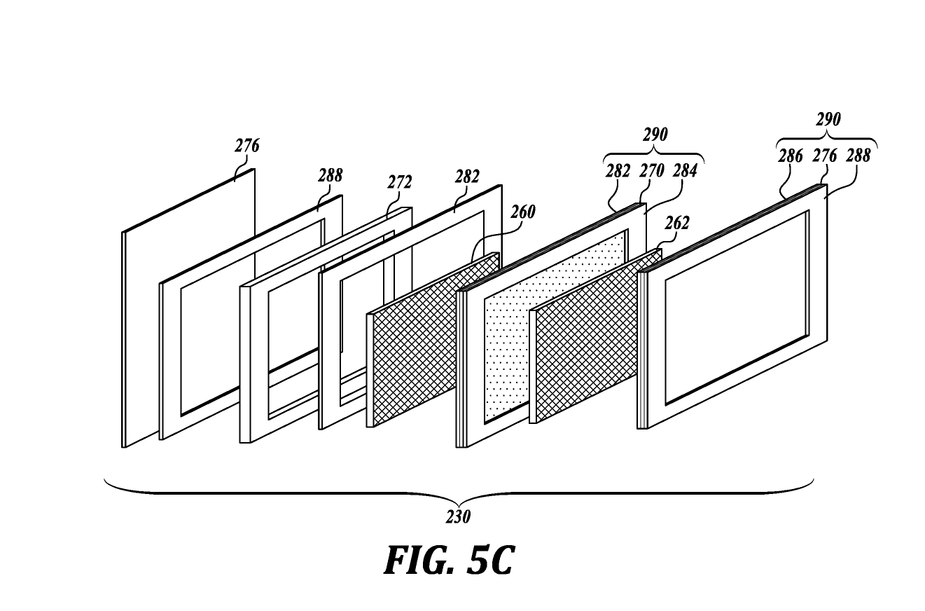

Embodiments of the present disclosure are directed to redox flow batteries (RFBs), systems and components thereof, stacks, strings, and sites, as well as methods of operating the same. Referring to FIGS. 1-3B, a redox flow battery 20 in accordance with one embodiment of the present disclosure is provided. Multiple redox flow batteries may be configured in a “string” of batteries, and multiple strings may be configured into a “site” of batteries. Referring to FIG. 4, a non-limiting example of a site is provided, which includes two strings 10, each having four RFBs 20. Referring to FIG. 5, another non-limiting example of a site is provided, which includes twenty strings 10, each having four RFBs 20. RFBs, systems and components thereof, stacks, strings, and sites are described in greater detail below.

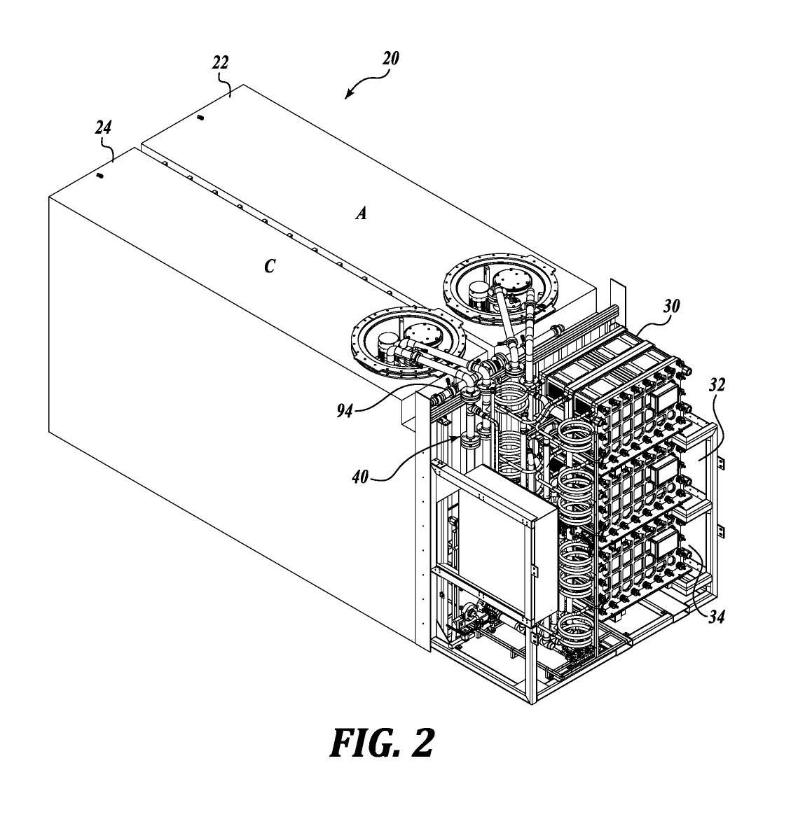

Referring to FIGS. 1 and 2, major components in an RFB 20 include the anolyte and catholyte tank assemblies 22 and 24, the stacks of electrochemical cells 30, 32, and 34, a system for circulating electrolyte 40, an optional gas management system 94, and a container 50 to house all of the components and provide secondary liquid containment.

FIG. 1 depicts the container 50 that houses, for example, the components shown in FIG. 2. The container 50 can be configured in some embodiments to be an integrated structure that facilitates or provides one or more of the following characteristics: compact design, ease of assembly, transportability, compact multiple-container arrangements and structures, accessibility for maintenance, and secondary containment.

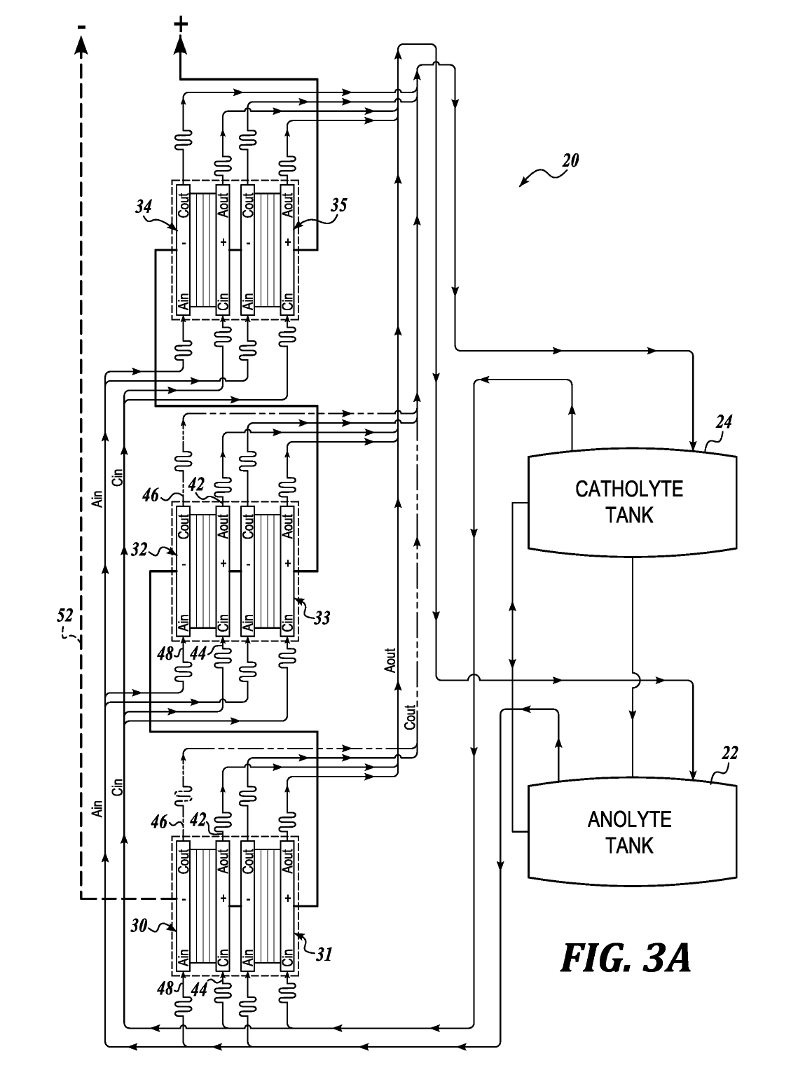

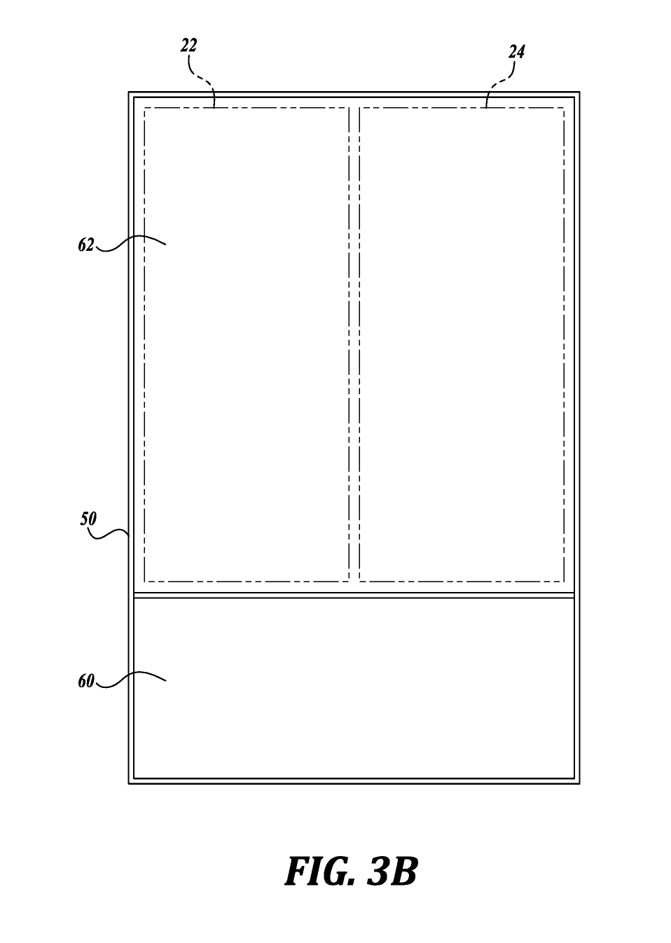

In the illustrated embodiment of FIGS. 1 and 2, the representative container 50 comprises two major compartments that house components of the RFB 20. In some embodiments, the division between the first and second compartments 60 and 62 is a physical barrier in the form of a bulkhead 70 (see FIG. 3B), which may be a structural or non-structural divider. The bulkhead 70 in some embodiments can be configured to provide secondary containment of the electrolyte stored in tank assemblies 22 and 24. In another embodiment, a secondary structural or non-structural division can be employed to provide a physical barrier between the anolyte tank 22 and the catholyte tank 24. In either case, as will be described in more detail below, the tanks 22 and 24 are configured as so to be closely fitted within the compartment or compartments, thereby maximizing the storage volume of electrolyte within the container 50, which is directly proportional to the energy storage of the battery 20. In the present disclosure, flow electrochemical energy systems are generally described in the context of an exemplary vanadium redox flow battery (VRB), wherein a V³⁺/V²⁺ sulfate solution serves as the negative electrolyte (“anolyte”) and a V⁵⁺/V⁴⁺ sulfate solution serves as the positive electrolyte (“catholyte”). However, other redox chemistries are contemplated and within the scope of the present disclosure, including, as non-limiting examples, vanadium sulfate systems, vanadium chloride systems, vanadium mixed sulfate and chloride systems, zinc-bromine systems, zinc-cerium systems, vanadium-bromide systems, sodium polysulfide-bromide systems, vanadium-iron systems, and iron-cromium systems, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺ vs. Ti²⁺/Ti⁴⁺, etc.

As a non-limiting example, in a vanadium flow redox battery (VRB) prior to charging, the initial anolyte solution and catholyte solution each include identical concentrations of V³⁺ and V⁴⁺. Upon charge, the vanadium ions in the anolyte solution are reduced to V²⁺/V³⁺ while the vanadium ions in the catholyte solution are oxidized to V⁴⁺/V⁵⁺.

Referring to the schematic in FIG. 3A, general operation of the redox flow battery system 20 of FIGS. 1 and 2 will be described. The redox flow battery system 20 operates by circulating the anolyte and the catholyte from their respective tanks that are part of the tank assemblies 22 and 24 into the electrochemical cells, e.g., 30 and 32. (Although only two electrochemical cells are needed to form a stack of cells, additional electrochemical cells in the illustrated embodiment of FIG. 3A include electrochemical cells 31, 33 and 35.) The cells 30 and 32 operate to discharge or store energy as directed by power and control elements in electrical communication with the electrochemical cells 30 and 32.

In one mode (sometimes referred to as the “charging” mode), power and control elements connected to a power source operate to store electrical energy as chemical potential in the catholyte and anolyte. The power source can be any power source known to generate electrical power, including renewable power sources, such as wind, solar, and hydroelectric. Traditional power sources, such as combustion, can also be used.

In a second (“discharge”) mode of operation, the redox flow battery system 20 is operated to transform chemical potential stored in the catholyte and anolyte into electrical energy that is then discharged on demand by power and control elements that supply an electrical load.

Each electrochemical cell 30 in the system 20 includes a positive electrode, a negative electrode, at least one catholyte channel, at least one anolyte channel, and an ion transfer membrane separating the catholyte channel and the anolyte channel. The ion transfer membrane separates the electrochemical cell into a positive side and a negative side. Selected ions (e.g., H+) are allowed to transport across an ion transfer membrane as part of the electrochemical charge and discharge process. The positive and negative electrodes are configured to cause electrons to flow along an axis normal to the ion transfer membrane during electrochemical cell charge and discharge (see, e.g., line e⁻ in FIG. 3A). As can be seen in FIG. 3A, fluid inlets 48 and 44 and outlets 46 and 42 are configured to allow integration of the electrochemical cells 30 and 32 into the redox flow battery system 20.

To obtain high voltage, high power systems, a plurality of single electrochemical cells may be assembled together in series to form a stack of electrochemical cells (referred to herein as a “stack,” a “cell stack,” or an “electrochemical cell stack”), e.g., 30 or 32 in FIG. 3A. Several cell stacks may then be further assembled together to form a battery system 20. A MW-level RFB system generally has a plurality of cell stacks, for example, with each cell stack having more than twenty electrochemical cells. As described for individual electrochemical cells, the stack is also arranged with positive and negative current collectors that cause electrons to flow through the cell stack generally along an axis normal to the ion transfer membranes and current collectors during electrochemical charge and discharge (see, e.g., line 52 shown in FIG. 3A).

The ion exchange membrane in each electrochemical cell prevents crossover of the active materials between the positive and negative electrolytes while supporting ion transport to complete the circuit. Ion exchange membrane material, in a non-limiting example, a perfluorinated membrane such as NAFION or GORE-SELECT, may be used in the electrochemical cells. Ion exchange through the membrane ideally prevents the transport of active materials between the anolyte and catholyte.

### String and Site Control System

As noted above, a string 10 is a building block for a multiple MW site. As seen in the exemplary layouts in FIG. 4, each string 10 includes four battery containers connected in series to a power and control system (PCS) 12 container. The control system for each string includes a battery management system (BMS) with local control provided by a human machine interface (HMI).

As a non-limiting example, an exemplary VRB may have capacity up to 125 kW for four hours (500 kW-hours) and a storage string may have capacity up to 500 kW for four hours (2 MW-hours). To be effective as a large scale energy storage system that can be operated to provide multiple layered value streams, individual batteries, designed and manufactured to meet economies of scale, may be assembled as building blocks to form multiple-megawatt sites, for example 5MW, 10MW, 20MW, 50MW, or more. Managing these large installations requires multi-level control systems, performance monitoring, and implementation of various communications protocols.

Referring to FIG. 4, an exemplary 1 MW system layout shows two 500 kW building block sub-assemblies or strings 10 that each include four battery modules 20 and one PCS module 102. Using this approach, multi-level larger systems may be assembled, for example, a single-level 10 MW system. As described in greater detail below, the unique combination of systems and components described herein provide significantly more energy density in a compact flowing electrolyte battery module 20 and string 10 design than previously designed flowing electrolyte batteries, such earlier generation VRBs. Other hybrid flowing electrolyte batteries, such as ZnBr2 systems, may demonstrate similar characteristics.

Described herein are systems and methods of operation designed to improve RFB performance on a battery, string, and site level.

### Cell Design

Referring to FIG. 5A, stacks 230 are commonly designed to include multiple cells 238, as can be seen in the electrochemical cell stack. In the illustrated embodiment of FIG. 5A, a plurality of cells are maintained between first and second end plates 250 and 252, held together by a system joiner 254, shown as a rod, nut, and spring connection system. The cells 238 in the stack 230 may be fluidicly in series or in parallel. An electrolyte manifold may include one or more flow paths to deliver electrolyte to or receive electrolyte from each cell 238 in the stack 230.

Referring to FIG. 5B, the components of a cell 238 are in an exploded view. The cell 238 includes a positive electrode (or cathode) 260, a negative electrode (or anode) 262, at least one catholyte flow field for flow of the catholyte through the positive electrode 260, at least one anolyte flow field for flow of the anolyte through the negative electrode 262, and an ion transfer membrane 270 separating the catholyte channel and the anolyte channel. In the illustrated embodiment, the electrochemical cell 238 includes first and second flow frames 272 and 274, for framing the positive and negative electrodes 260 and 262 and providing electrolyte flow to and from the catholyte and anolyte flow fields in the respective positive and negative electrodes 260 and 262.

In addition, each electrochemical cell includes bipolar plates 276 at the ends of the cell 238. The bipolar plates 276 are used as current conductors with the cells 238. In the illustrated embodiment, single bipolar plates 276 are shared between adjacent cells 238. As a non-limiting example, the bipolar plate 276 have a thickness of about 1 mm.

Referring to FIG. 5B, the two flow frames (e.g., 272 and 274) can be used support the cell 238 and may establish the four electrolyte paths to the cell 238: anolyte out, catholyte in, catholyte out, anolyte in. In that regard, the cell flow frames 272 and 274 may include electrolyte manifold holes for delivery and/or receipt of electrolyte to and from the stack 230. Therefore, the first flow frame 272 may support the catholyte flow field by providing catholyte-in and catholyte-out holes. The second flow frame 274 may supports the anolyte flow field by providing anolyte-in and anolyte-out holes.

Sealing structures 282 and 284, such as gaskets, can be used to prevent leakage from the flow frames 272 and 274 for the catholyte and anolyte flow fields 260 and 262. In accordance with embodiments of the present disclosure, the gaskets 282 and 284 can be pre-assembled with a separator, which may be a membrane 270 or a bipolar plate 276, as a gasket-and-separator assembly 290 (see FIG. 5C).

In previously designed cells, discrete gaskets are placed to sandwich the membranes 270 and the bipolar plates 276 in the cell stack 230 to prevent internal and external leakage of electrolyte. When assembling a cell stack 230, all components must be aligned precisely to ensure a good seal and to achieve adequate electrolyte flow through the surface area of membrane. However, quality control for mass production of cell stacks 230 can be difficult when each component is independently placed in the cell. Misalignment of the battery cell stack 230 can cause electrolyte leakage and/or material corrosion, battery short out, and further damage to the battery system's long term stability and lifespan. When misalignment occurs, the stack has to be disassembled and reassembled. In most cases, it is not possible to reuse all the components of the stack, resulting in membrane waste.

In addition to manufacturing issues, the membrane is expensive material. Therefore, area of the membrane covered by the gasket is not used for ionic exchange and is wasted material.

Embodiments of the present disclosure are directed to manufacturing improvements for the cell stack, improved leakage prevention in the cell stack, improved efficiency in the use of membrane material, and strengthened protection for the membrane edge.

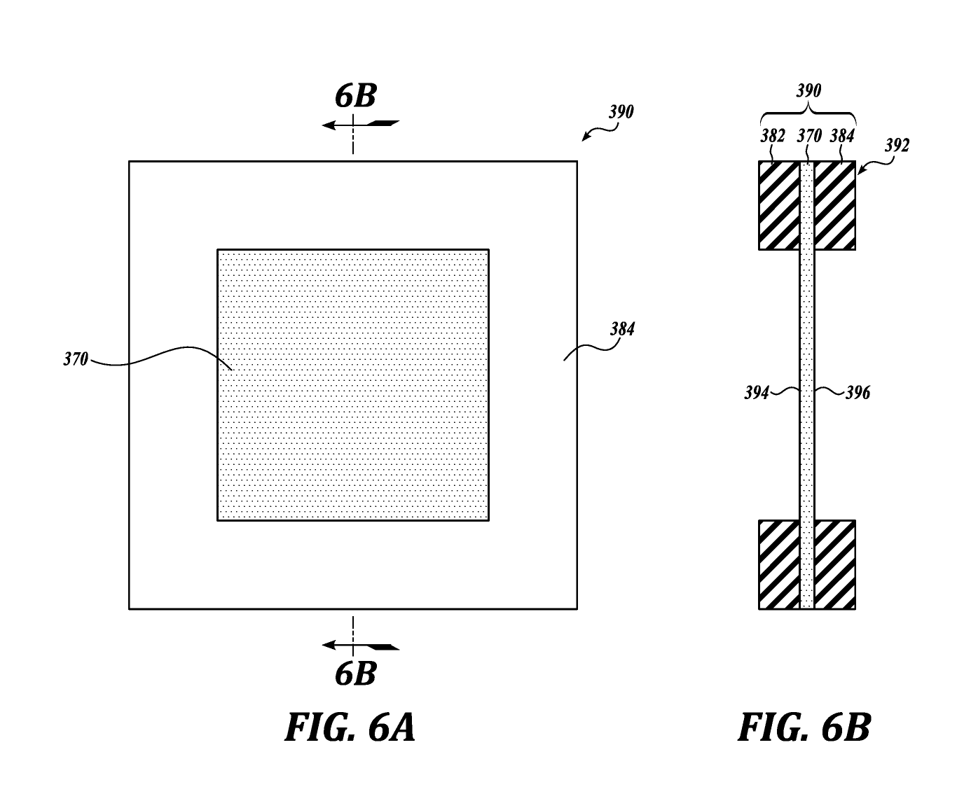

Referring to FIGS. 6A and 6B, in accordance with embodiments of the present disclosure, the gasket assembly 392 includes a first gasket 382 and a second gasket 384 in a sandwich configuration with a separator 370 (such as a membrane or a bipolar plate). A gasket-and-separator assembly 390 includes a gasket assembly 392 laminated to the separator 370. The gasket assembly 392 seals against the other perimeter of the separator 370 on each of the first side 394 and the second side 396 of the separator 370. In the illustrated embodiment, the other perimeter of the separator 370 is aligned with the outer perimeter of each of the first and second gaskets 382 and 384. The first and second gaskets 382 and 384 are substantially flat gaskets of identical or substantially similar construction. Therefore, the first and second gaskets 382 and 384 may be interchangeable.

In embodiments of the present disclosure, the gasket material for the gasket assembly may be a rubber material selected from the group consisting of acrylonitrile butadiene styrene (ABS) rubber, fluorine rubber, chloroprene rubber, nitrile butadiene rubber, polyisoprene rubber, natural rubber, butyl rubber, ethylene propylene diene monomer (EPDM) rubber, polybutadiene rubber, acrylic rubber, silicone rubber, and combinations thereof.

The membrane may be a cation exchange membrane, an anion exchange membrane, or a porous separator. The membrane may have a thickness in a range of 1 to 300 microns.

In embodiments of the present disclosure, the gasket assembly 392 is laminated to the separator 370 before the cell stack 230 shown in FIG. 5A is assembled. In accordance with embodiments of the present disclosure, the gasket assembly 392 may be laminated to the separator 370 by using a press for a predetermined time and pressure. The gaskets have high elasticity and surface roughness, such that when they are pressed with an elastic membrane, local vacuums can be formed and ensure the gasket and membrane assembly is firmly laminated together. Likewise, when the gaskets are pressed with other similar gaskets, local vacuums can be formed and ensure the gasket and membrane assembly is firmly laminated together.

Prior to assembly, the gasket surfaces can be prepared for assembly. For example, the gasket surfaces can be degreased using volatile solvents including toluene, acetone, methyl ethyl ketone, methyl alcohol, isopropyl alcohol or trichloroethylene, abraded with plastic razor blades or plastic gasket scrapers, and treated using chemical solvents including trichloroethylene solvent, modified bleach solution, or sulfuric acid solution.

In some embodiments, the pressing pressure may be in the range of 0.01 to 100 MPa. In some embodiments, the pressing time may be in the range of 0.01 to 1000 minutes. After lamination, the gasket assembly 392 may be delaminated from the separator 370 without damage to the separator 370 and optionally repressed if one or more gaskets of the gasket assembly needs to be replaced or realigned.

In some embodiments, multiple gasket-and-separator assemblies can be made at the same time in a pressing apparatus by separating the gasket-and-separator assemblies with paper, plastic sheets, metal plates, special fixtures, or by directly using the battery stack hardware.

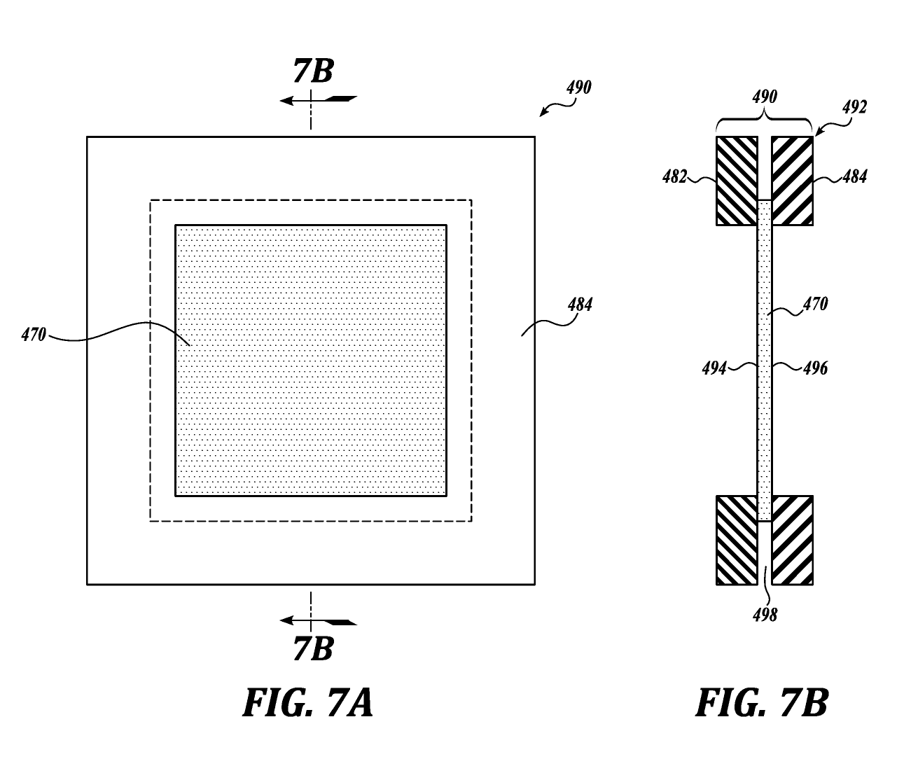

Referring to FIGS. 7A and 7B, in accordance with another embodiment of the present disclosure, the gasket-and-separator assembly 490 is substantially similar to the gasket-and-separator assembly 390 of FIGS. 6A and 6B, except the other perimeter of the separator 470 is not aligned with the outer perimeter of each of the first and second gaskets 482 and 484. Therefore, prior to lamination, there is a space 498 between the first and second gaskets 482 and 484. In this embodiment, less separator material can be used for separation purposes because the separator does not extend to the outer perimeter of the first and second gaskets 482 and 484, thereby reducing the amount and cost of the separator 470.

In the embodiment of FIGS. 7A and 7B, when pressed, the thickness of the gasket-and-separator assembly 490 may be reduced at the outer perimeter of the first and second gaskets 482 and 484 in view of the space 498 between the first and second gaskets 482 and 484 at the outer perimeter.

In comparison, in the embodiment of FIGS. 6A and 6B, when pressed, there is no space (due to the presence of the separator 470) between the first and second gaskets 382 and 384 at the outer perimeter. Accordingly, in FIGS. 6A and 6B, the thickness of the gasket-and-separator assembly 390 is not reduced at the outer perimeter of the first and second gaskets 382 and 384.

A reduced thickness in the gasket-and-separator assembly 490 may cause, in some cases, alignment problems in the cell stack 230 (see FIG. 5A). Therefore, the following embodiments are directed to gasket-and-separator assemblies having substantially uniform cross-sectional gasket thickness.

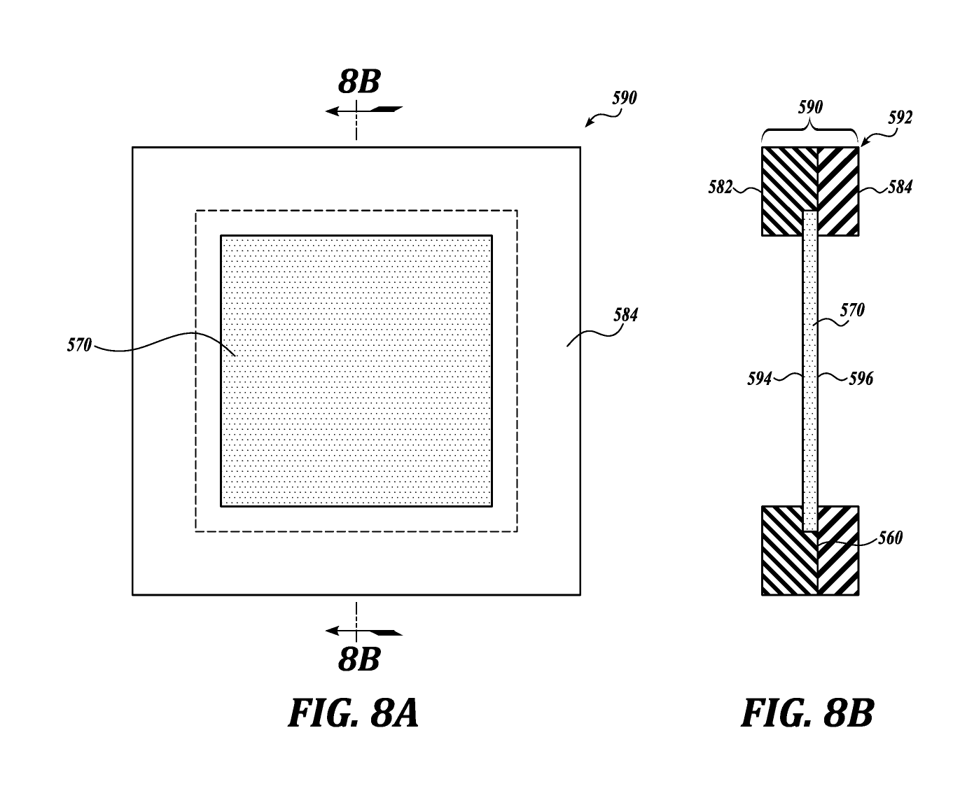

Referring to FIGS. 8A and 8B, in accordance with another embodiment of the present disclosure, the gasket-and-separator assembly 590 is substantially similar to the gasket-and-separator assemblies of the previously described embodiments, except the gasket-and-separator assembly 590 includes first and second gaskets 582 and 584 that are not identical. The first gasket 582 includes a stepped portion 560 along the inner perimeter of the gasket 582, with the stepped portion 560 sized and configured to receive the separator 570. In the illustrated embodiment, the step of the stepped inner surface of the first gasket 582 has substantially the same thickness as the separator, when assembled. In another embodiment, the step of the stepped inner surface of the first gasket 582 has substantially the same thickness as the separator, when pressed. In accordance with embodiments described herein, the term “substantially” is meant to mean within engineering tolerances and/or +/−5%.

In view of the stepped portion 560, the thickness of the gasket-and-separator assembly 590 is not reduced at the outer perimeter of the first and second gaskets 582 and 584 when pressed. (Compare the embodiment of FIGS. 7A and 7B.) The first gasket 582 with the stepped portion 560 may be molded in such shape.

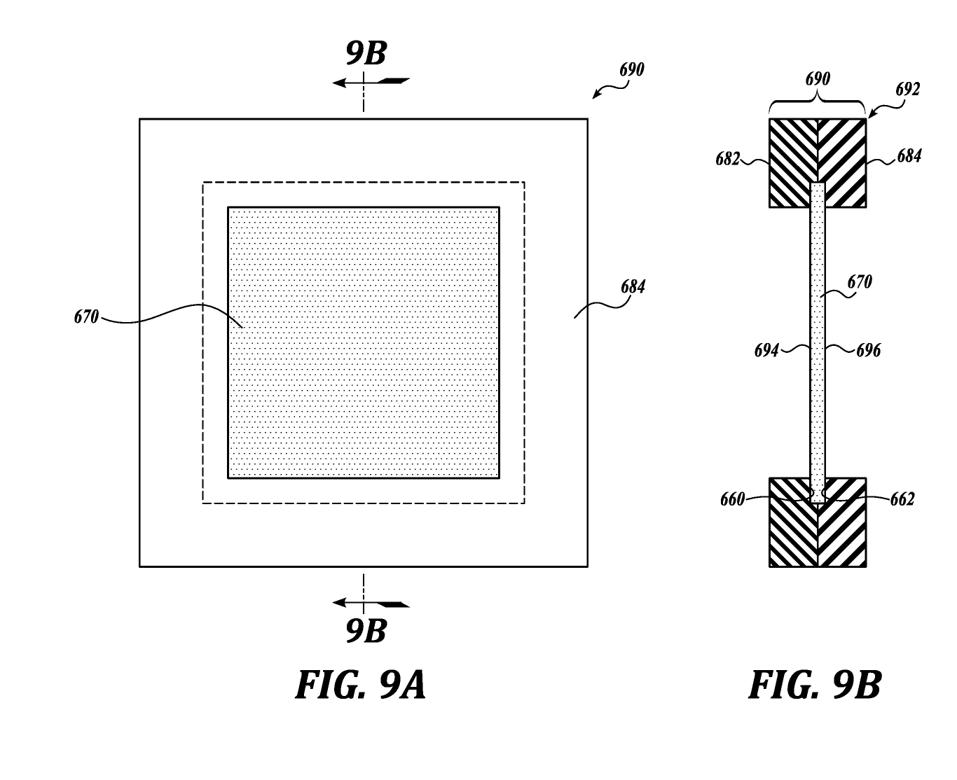

Referring to FIGS. 9A and 9B, in accordance with another embodiment of the present disclosure, the gasket-and-separator assembly 690 is substantially similar to the gasket-and-separator assemblies of the previously described embodiments, except the gasket-and-separator assembly 690 includes first and second gaskets 682 and 684 having identical or substantially similar stepped portions 660 and 662 along the inner perimeters of the gaskets 682 and 684, the stepped portions 660 and 662 sized and configured to receive half of the thickness of the separator 670. In the illustrated embodiment, the steps of the stepped inner surfaces of the first and second gaskets 682 and 684 each have substantially ½ the thickness as the separator, when assembled. In another embodiment, the steps of the stepped inner surfaces of the first and second gaskets 682 and 684 each have substantially ½ the thickness as the separator, when pressed.

In view of the stepped portions 660 and 662, the thickness of the gasket-and-separator assembly 690 is not reduced at the outer perimeter of the first and second gaskets 682 and 684 when pressed. (Compare the embodiment of FIGS. 7A and 7B.) The first and second gasket 682 and 684 with the stepped portions 660 and 662 may be molded in such shape and reversed for use as either the first or second gasket 682 or 684.

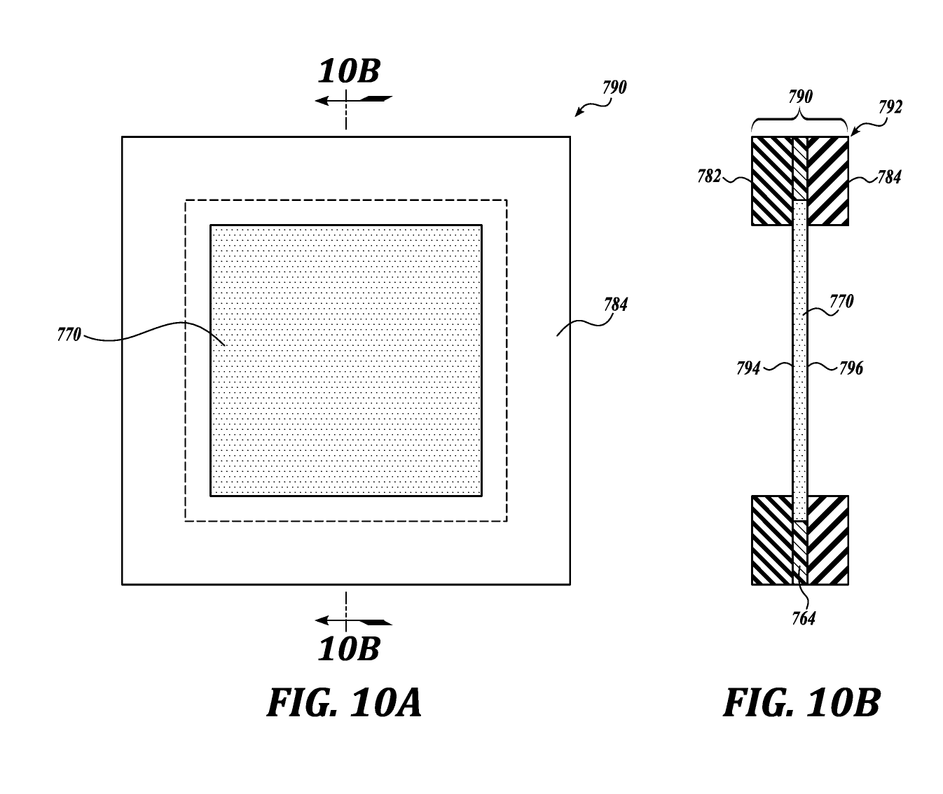

Referring to FIGS. 10A and 10B, in accordance with another embodiment of the present disclosure, the gasket-and-separator assembly 790 is substantially similar to the gasket-and-separator assemblies of the previously described embodiments, except the gasket-and-separator assembly 790 may include a filler portion 764 sandwiched between the first and second gaskets 782 and 784 to fill the spacing (see the spacing 498 in FIGS. 7A and 7B). The filler portion 764 may be a third gasket (made from gasket material) or a plastic material having the same or substantially the same thickness as the membrane.

In view of the filler portion 764, the thickness of the gasket-and-separator assembly 790 is not reduced at the outer perimeter of the first and second gaskets 782 and 784 when pressed. (Compare the embodiment of FIGS. 7A and 7B.) In the illustrated embodiment of FIGS. 10A and 10B, the first and second gaskets 782 and 784 are substantially flat gaskets of identical or substantially similar construction. Therefore, the first and second gaskets 782 and 784 may be interchangeable.

The filler portion 764 made from a plastic material may be used to reduce cost because the plastic material is less costly than a third gasket (made from gasket material). Suitable plastic film materials may include, but are not limited to, polyvinyl chloride (PVC), chlorinated polyvinyl chloride (CPVC), polypropylene (PP), polyvinylidene fluoride (PVDF), polyamide (PA), acrylonitrile butadiene styrene (ABS), polyethylene terephthalate (PET), polytetrafluoroethylene (PTFE), and combinations thereof.

When the separator is a bipolar plate, the filler portion 764 may be a third gasket portion 764 sandwiched between the first and second gaskets 782 and 784. Because the bipolar plate is a relatively hard and smooth surface of graphite or metal, the gaskets do not laminate as readily to the bipolar plate as they do to a membrane (which has more surface roughness). The use of three gaskets 782, 784, and 764 allow the gaskets to laminate to each other (having high elasticity and relatively rough surfaces) and the bipolar plate to be lodged in place surrounded by the frame formed by the gasket assembly 792. Likewise, the use of stepping gaskets (as seen in FIGS. 8A, 8B, 9A, and 9B) allow the gaskets to laminate to each other (having high elasticity and relatively rough surfaces) and the bipolar plate to be lodged in place surrounded by the frame formed by the gasket assembly 592 (see FIGS. 8A and 8B) and 692 (see FIGS. 9A and 9B).

Because the bipolar plate does not have high elasticity like the membrane, the filler portion 764 gasket can have an increased thickness than the bipolar plate to account for deformation of the filler portion 764 gasket during pressing. For example, in one embodiment, the filler portion 764 gasket has an increased thickness of 0% to 50% than the thickness of the bipolar plate prior to pressing. In another embodiment, the filler portion 764 gasket has an increased thickness of 10% to 30% than the thickness of the bipolar plate prior to pressing. When stepping gaskets are used, such as the stepping gaskets in FIGS. 9A and 9B, the thickness increase can be cut in half for each step 660 and 662.

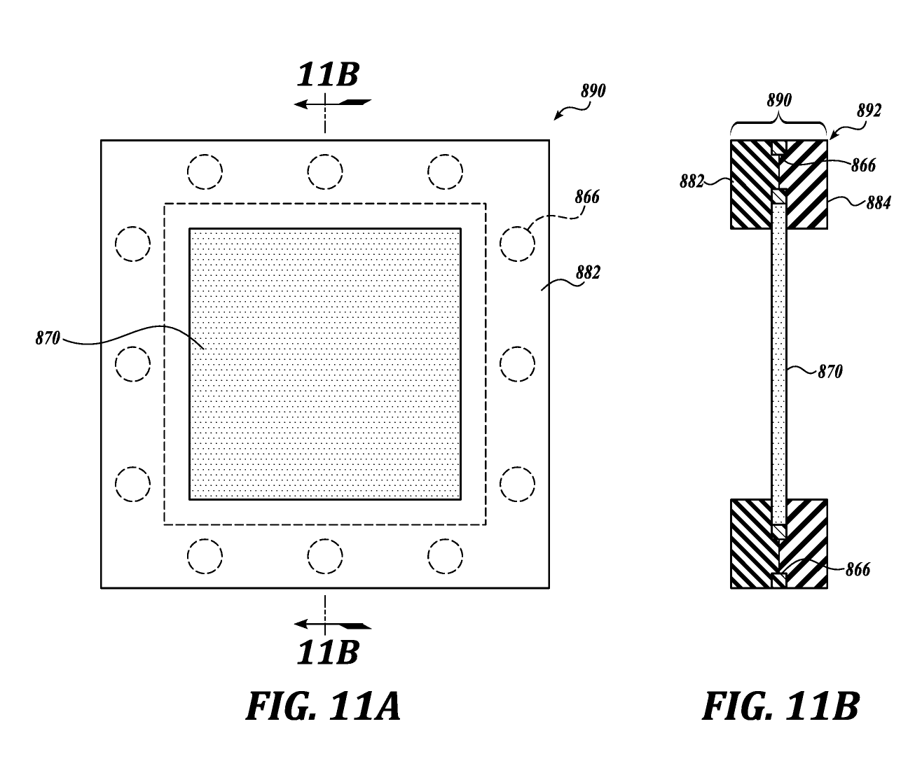

Referring to FIGS. 11A and 11B in accordance with another embodiment of the present disclosure, the gasket-and-separator assembly 890 is substantially similar to the gasket-and-separator assemblies of the previously described embodiments, except the plastic film is a continuous frame surrounding the outer perimeter of the separator 870, but the plastic structure 864 has been punched with multiple holes 866 before being pressed together. The plastic structure 864 provides structure to resist deformation during pressing. The first and second gaskets 882 and 884 are pressed and laminate with each other through the holes 866 in the plastic film 864. The punched holes 866 in the plastic structure 864 may be regular or random.

While illustrative embodiments have been illustrated and described, it will be appreciated that various changes can be made therein without departing from the spirit and scope of the invention.

The embodiments of the invention in which an exclusive property or privilege is claimed are defined as follows:

1. A cell in a redox flow battery, the cell comprising:
a first flow frame for flow of a catholyte, a second flow frame for flow of an anolyte, and a separator between the first flow frame and the second flow frame, wherein the separator has a first side and a second side and an outer perimeter; and
a gasket-and-separator assembly including a gasket assembly laminated to the separator, wherein the gasket assembly seals the outer perimeter of the separator on the first side and the second side.

2. The cell of claim 1, wherein the separator is a membrane or a bipolar plate.

3. The cell of claim 1, wherein the outer perimeter of the separator is aligned with the outer perimeter of the gasket assembly.

4. The cell of claim 1, wherein the outer perimeter of the separator is embedded within the gasket assembly.

5. The cell of claim 1, wherein the gasket assembly includes a first gasket and a second gasket.

6. The cell of claim 5, wherein the first gasket contacts the first side of the separator and the second gasket contacts the second side of the separator.

7. The cell of claim 5, wherein the gasket-and-separator assembly is formed by pressing the separator between the first gasket and the second gasket.

8. The cell of claim 5, wherein the first and second gaskets have flat inner and outer surfaces.

9. The cell of claim 5, wherein at least one of the first and second gaskets has a stepped inner surface.

10. The cell of claim 9, wherein the step of the stepped inner surface has substantially the same thickness as the separator.

11. The cell of claim 9, wherein the step of the stepped inner surface has substantially ½ the thickness of the membrane.

12. The cell of claim 5, further comprising a filler portion between the first and second gaskets.

13. The cell of claim 12, wherein the filler portion is a plastic film or a third gasket.

14. The cell of claim 13, wherein the plastic film is selected from the group consisting of polyvinyl chloride (PVC), chlorinated polyvinyl chloride (CPVC), polypropylene (PP), polyvinylidene fluoride (PVDF), polyamide (PA), acrylonitrile butadiene styrene (ABS), polyethylene terephthalate (PET), polytetrafluoroethylene (PTFE), and combinations thereof.

15. The cell of claim 7, wherein the pressing pressure is in the range of 0.01 to 100 MPa.

16. The cell of claim 7, wherein the pressing time is in the range of 0.01 to 1000 minutes.

17. The cell of claim 1, wherein the material for the gasket assembly is a rubber material selected from the group consisting of acrylonitrile butadiene styrene (ABS) rubber, fluorine rubber, chloroprene rubber, nitrile butadiene rubber, polyisoprene rubber, natural rubber, butyl rubber, ethylene propylene diene monomer (EPDM) rubber, polybutadiene rubber, acrylic rubber, silicone rubber, and combinations thereof.

18. A method of making a cell for a redox flow battery, the method comprising:
laminating a gasket-and-separator assembly including a gasket assembly laminated to the separator, wherein the separator has a first side and a second side and an outer perimeter and wherein the gasket assembly seals the outer perimeter of the separator on the first side and the second side; and
disposing the gasket-and-separator assembly between a first flow frame for flow of a catholyte, a second flow frame for flow of an anolyte.

19. The method of claim 18, wherein the surface of the gasket assembly is prepared prior to pressing.

20. A redox flow battery stack of cells, the stack comprising:
a plurality of adjacent cells, each cell including a first flow frame for flow of a catholyte, a second flow frame for flow of an anolyte, and a separator between the first flow frame and the second flow frame, wherein the separator has a first side and a second side and an outer perimeter; and
a gasket-and-separator assembly including a gasket assembly laminated to the separator, wherein the gasket assembly seals the outer perimeter of the separator on the first side and the second side.
